(19) United States
(12) Patent Application Publication
(10) Pub. No.: US 2013/0223987 A1
(43) Pub. Date: Aug. 29, 2013

(54) Turbine Nozzle Insert

(71) Applicants: Scott Stafford, San Diego, CA (US); Xubin Gu, San Diego, CA (US)

(72) Inventors: Scott Stafford, San Diego, CA (US); Xubin Gu, San Diego, CA (US)

(21) Appl. No.: 13/409,028

(22) Filed: Feb. 29, 2012

(51) Int. Cl. F02C 7/18; B23P 15/00; F02C 7/00

(52) U.S. Cl. 415/115; 415/232; 29/888.02

(57) ABSTRACT

A turbine nozzle insert of a gas turbine engine is disclosed. The insert may comprise an elongated hollow body portion, a flange portion formed at a first end of the elongated body portion, and a contact portion formed at a second end of the elongated body portion opposite the first end.

### TECHNICAL FIELD

The present disclosure relates generally to gas turbine engine (GTE) turbine nozzles, and more particularly to an insert for a GTE turbine nozzle.

### BACKGROUND

GTEs produce power by extracting energy from a flow of hot gas produced by combustion of fuel in a stream of compressed air. In general, turbine engines have an upstream air compressor coupled to a downstream turbine with a combustion chamber (“combustor”) in between. Energy is released when a mixture of compressed air and fuel is burned in the combustor. In a typical turbine engine, one or more fuel injectors direct a liquid or gaseous hydrocarbon fuel into the combustor for combustion. The resulting hot gases are directed over blades of the turbine to spin the turbine and produce mechanical power.

In high performance GTEs, a portion of the compressed air is used to cool GTE components, for example turbine components, exposed to hot gas flow. GTEs include cooling passages and cooling flows for receiving the portion of compressed air to improve reliability and cycle life of individual components within the GTE. GTE components, such as stationary turbine guide vanes, commonly referred to as turbine nozzles, are arranged such that the portion of compressed air flows through a plurality of internal cooling passages of the turbine nozzles.

U.S. Patent Application Publication No. 2010/0054915 to Devore et al. (the '915 publication) describes an airfoil insert for an airfoil of a gas turbine engine. According to the apparatus described in the '915 publication, an airfoil insert allows for convective cooling of interior surfaces of turbine airfoils exposed to high-temperature working fluid flow. One embodiment of the insert described in the '915 publication includes spacing tabs formed on an exterior of the insert wall that extend within a cross-sectional area of a cooling passage of the airfoil.

### SUMMARY

In one aspect, an insert for an airfoil is disclosed. The insert may include an elongated hollow body portion, a flange portion formed at a first end of the elongated body portion, and a contact portion formed at a second end of the elongated body portion opposite the first end.

In another aspect, a turbine nozzle of a gas turbine engine is disclosed. The turbine nozzle may include a plurality of airflow passages formed within the turbine nozzle, and an insert disposed within one of the plurality of airflow passages. The insert may include an elongated hollow body portion extending along a length of the one of the plurality of passages, a flange portion formed at a first end of the elongated body portion and extending from the one of the plurality of passages, and a contact portion formed at a second end of the elongated body portion opposite the first end.

In yet another aspect, a method of manufacturing or remanufacturing a turbine nozzle having a plurality of internal passages. The method may include providing an insert having an elongated hollow body portion, a flange portion formed at a first end of the elongated body portion, and a contact portion formed at a second end of the elongated body portion opposite the first end. The method may further include inserting the contact portion into the one of the plurality of passages, and fixing the flange portion to the turbine nozzle.

### BRIEF DESCRIPTION OF THE DRAWINGS

FIG. 1 is an isometric view of a turbine nozzle of a GTE;

FIG. 2 is a sectional view of a turbine nozzle of a GTE including a nozzle insert;

FIG. 3 is an isometric view of a nozzle insert;

FIG. 4 is an enlarged sectional view of the nozzle insert of FIG. 2 taken along line 4-4;

FIG. 5 is an enlarged sectional view of the nozzle insert of FIG. 2 taken along line 5-5;

FIG. 6 is an enlarged sectional view of the nozzle insert of FIG. 2 taken along line 6-6;

FIG. 7 is an enlarged sectional view of the nozzle insert of FIG. 2 taken along line 7-7;

FIG. 8 is a sectional view of the turbine nozzle of FIG. 1 taken alone line 8-8; and

FIG. 9 is a flow diagram showing a method of manufacturing a turbine nozzle having an insert.

### DETAILED DESCRIPTION

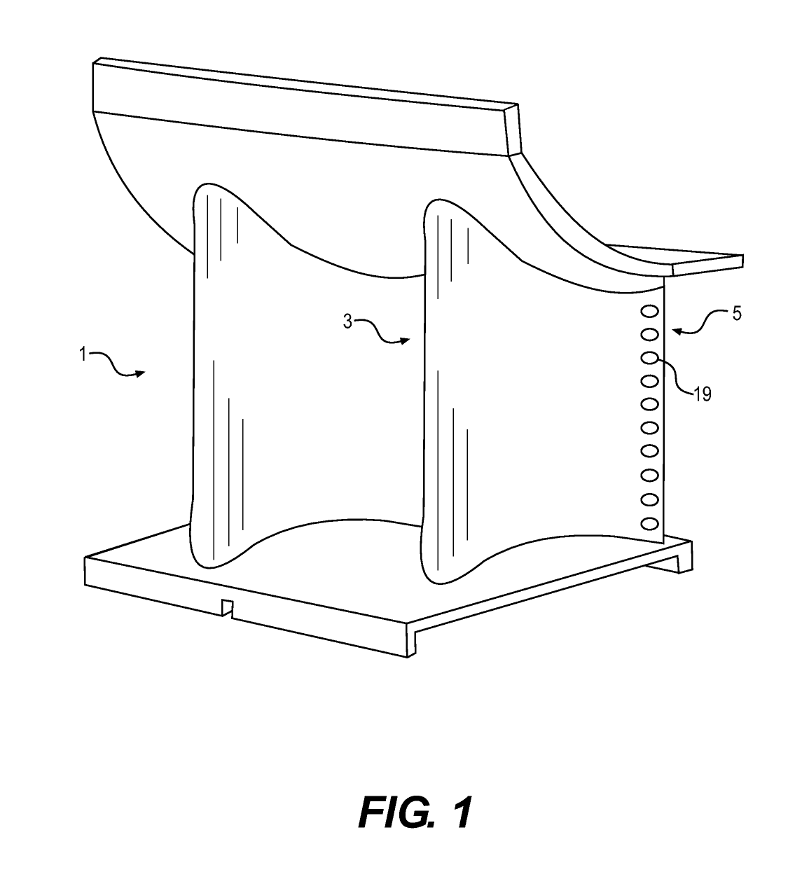

FIG. 1 is a view of a turbine nozzle 1 of a GTE. Gas from the combustor section of the GTE (not shown), for example an axial GTE, may flow through a stationary structure of the turbine section of the GTE. The stationary structure may include a plurality of stationary guide vanes, or turbine nozzles 1, to guide a flow of air from the combustor section of the GTE. As described in more detail below, a turbine nozzle 1 may be an airfoil having internal passages capable of receiving and directing or guiding a flow of fluid, such as cooling air.

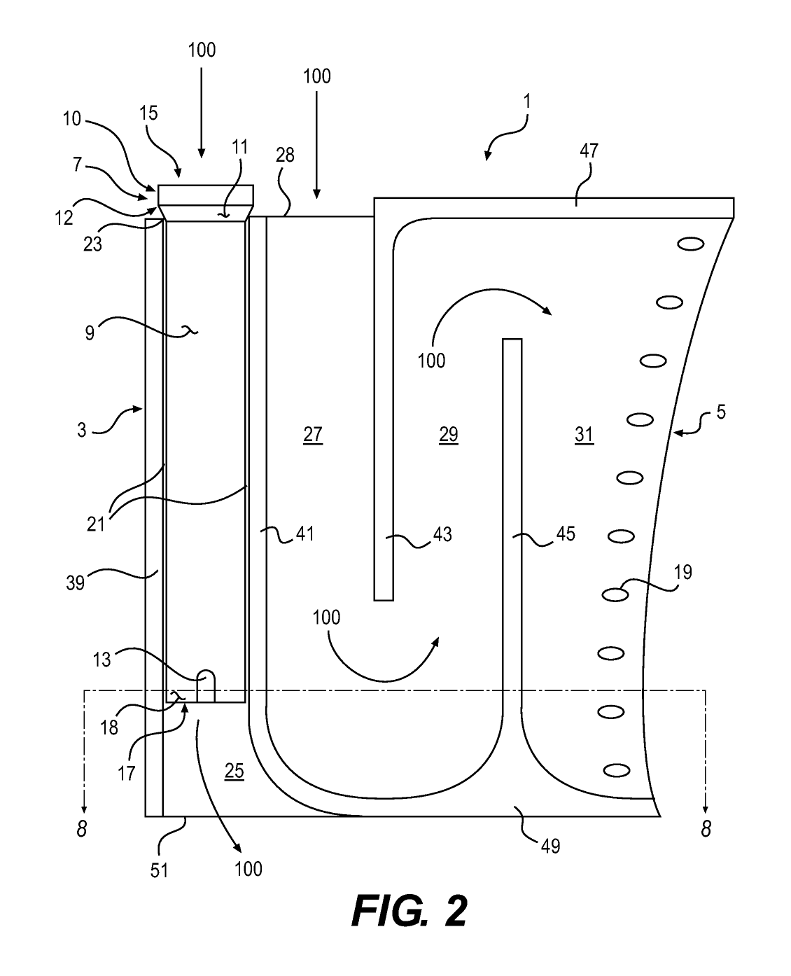

FIG. 2 illustrates a sectional view of an airfoil, such as the turbine nozzle 1, including an insert 7. The turbine nozzle 1 may be a conventional turbine nozzle of a first stage turbine assembly of a GTE (not shown). The turbine nozzle 1 is an airfoil having a leading edge 3 and a trailing edge 5, where the leading edge 3 is disposed in an airflow from the combustor section of the GTE (not shown) upstream of the trailing edge 5. The turbine nozzle 1 includes a plurality of internal airflow cooling passages through which a portion of compressed cooling air 100 can flow. For example, the turbine nozzle 1 of FIG. 2 includes a first passage 25 adjacent the leading edge 3, a second passage 27, a third passage 29, and a fourth passage 31 adjacent the trailing edge 5. The passages may be defined by a plurality of walls forming the turbine nozzle 1, for example, first, second, third, and fourth turbine nozzle side walls 39, 41, 43, and 45, respectively, as well as a turbine nozzle upper wall 47 and a turbine nozzle lower wall 49. In some instances, the turbine nozzle 1 may be provided with more or less than four internal cooling airflow passages arranged in any direction or plurality of directions through the interior of the turbine nozzle 1.

As shown in FIG. 2, the insert 7 includes an elongated body portion 9 that, when the insert 7 is disposed within the first passage 25, extends along at least a portion of a length of the first passage 25. When the insert 7 is disposed within the first passage 25, a gap 21 may exist between the insert body portion 9 and the first and second side walls 39 and 41, respectively. Additionally, a space may exist between an outlet 17 of the insert 7 and the outlet 51 of the first passage 25. While FIG. 2 shows the insert 7 being disposed within the first passage 25 adjacent the leading edge 3 of the turbine nozzle 1, the insert 7 may be disposed in, for example, the second passage 27 or any additional passage capable of receiving the insert 7.

When the insert 7 is disposed within the first passage 25 as shown in FIG. 2, the insert 7 may be fixed to a top portion of the first passage 25 at a fixing location 23. Specifically, one end of the insert 7 may include an inlet 15 and a flange 11 to allow fixation of the insert 7 within the first passage 25 at the fixing location 23. The flange 11 may include a substantially straight portion 10 that is wider than the body of the insert 9, as will be described in more detail below, wherein the straight portion 10 extends substantially parallel to the body 9 of the insert. As shown in FIG. 2, the flange 11 may further include a tapered portion 12 that tapers at a predetermined angle toward the body 9 of the insert 7. In some embodiments, the tapered portion 12 may taper at an angle of between 10 and 20 degrees with respect to a line parallel to the straight portion 10 of the flange 11. In other embodiments, the flange 11 may taper at an angle of less than 10 degrees, or greater than 20 degrees. The flange 11 may be fixed by welding, for example laser welding, or brazing, to part of the nozzle 1, such as the first and second side walls 39 and 41, respectively. As shown in FIG. 2, the flange 11 may extend from the first passage 25 to a location outside of the first passage 25.

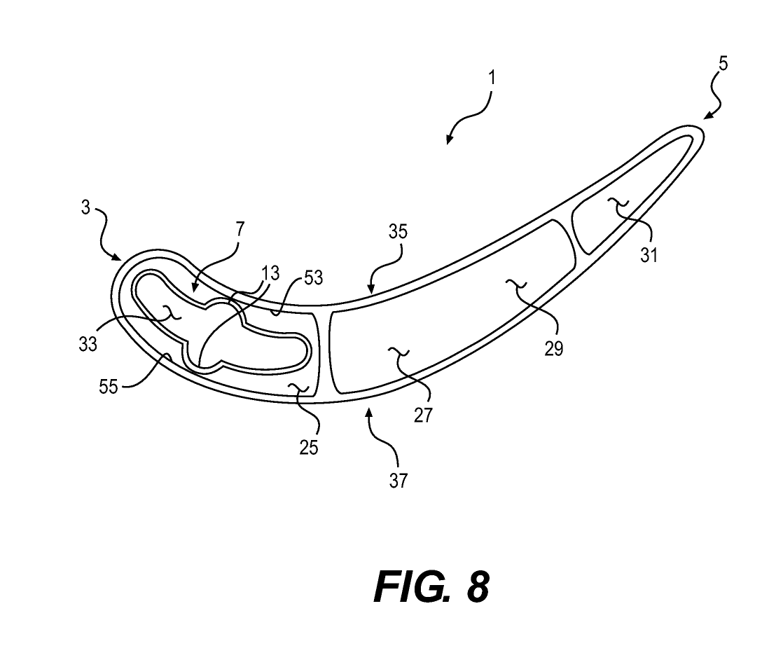

Another end 18 (referred to herein as the “free end”) of the insert 7 opposite the flange 11 may be freely disposed within the first passage 25. “Freely disposed” as used herein may refer to a component or portion of a component that is not affixed to another component. The free end 18 includes an outlet 17 and a contact portion 13, described in more detail below. The contact portion 13 contacts inner walls 53 and 55 and supports the insert 7 within the first passage 25 (FIG. 8).

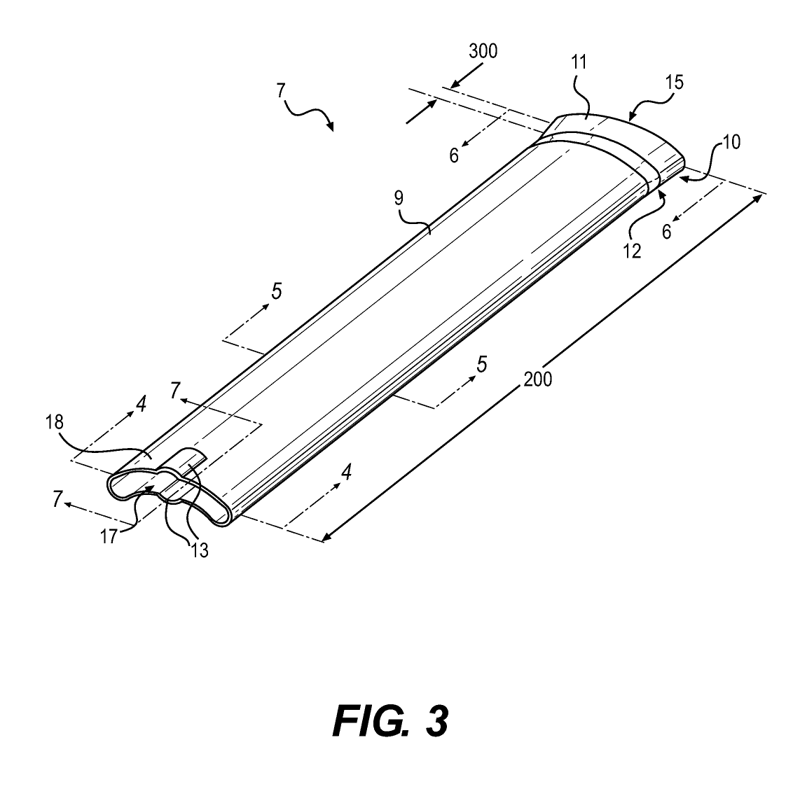

FIG. 3 illustrates a view of the nozzle insert 7 in isolation from the turbine 1 nozzle. In some embodiments the insert 7 is comprised of a metal, for example a sheet metal. As shown in FIG. 3, the insert 7 has a hollow interior and a total length 200. The length 200 may be less than a length of the turbine nozzle internal flow passage in which the insert 7 is disposed as shown in FIG. 2. In other embodiments, however, the length 200 of the insert 7 may be substantially the same as or greater than the length of the turbine nozzle internal flow passage, for example the first passage 25, in which the insert 7 is disposed. While the total length 200 of the insert 7 may be any length depending on the size of the turbine nozzle 1, in one exemplary embodiment the total length 200 is between about 10.541 and 10.643 cm (4.150 and 4.190 inches). Additionally, the straight portion 10 of the flange 11 has a flange length 300 extending in the same direction along the length of the insert 7 as the total length 200. While the flange length 300 may be any length depending on the size of the insert 7, in one exemplary embodiment the flange length 300 is between about 0.406 and 0.508 cm (0.160 and 0.200 inches).

As shown in FIG. 3 and described in more detail below, the contact portion 13, which may also be referred to as “ribs,” “lugs,” or “standoffs,” may include two protrusions on opposite sides of the insert 7. The contact portion 13 may be deformable, and may have a rounded shape, for example, as shown in FIG. 3, the contact portion 13 can include deformable cylindrically shaped portions. Additionally, in alternate embodiments a plurality of contact portions 13 may be provided.

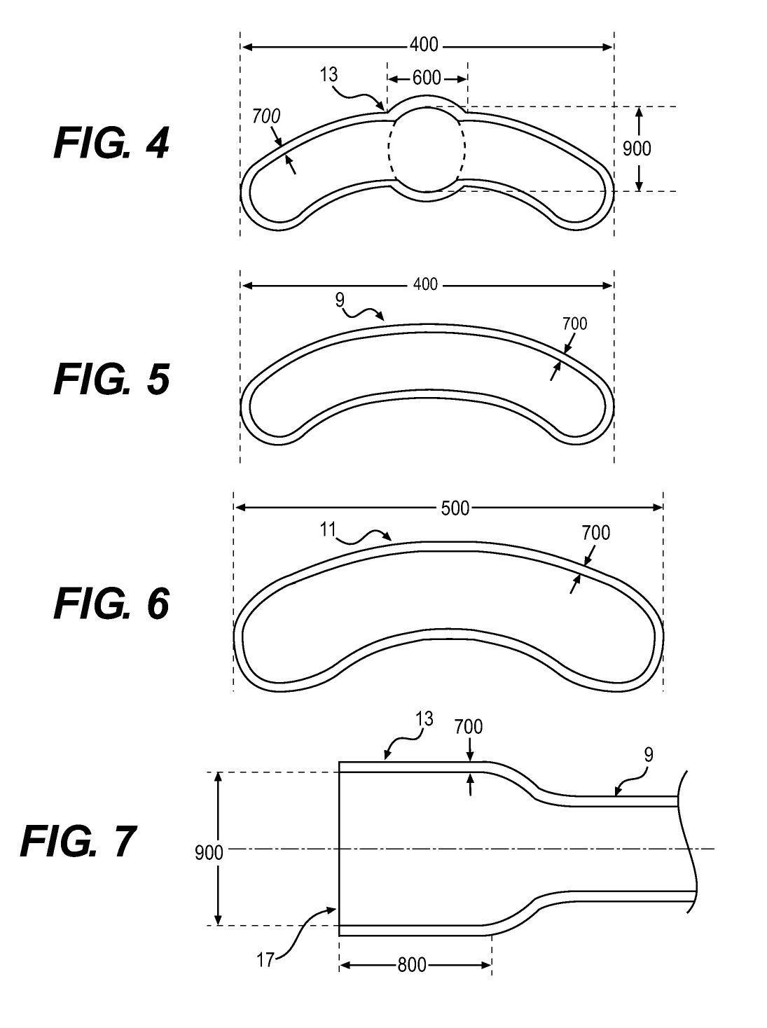

FIGS. 4-7, which illustrate various cross-sectional views of the insert 7 shown in FIG. 3, will now be described. In FIG. 4, taken along line 4-4 of FIG. 3, the free end 18 of the insert 7 having the contact portion 13 is shown. As shown in FIG. 4 (as well as FIGS. 5 and 6), the insert 7 has a cross-sectional shape which may be referred to as “bent” or “bowed.” The bent or bowed shaped insert 7 may be symmetrical with respect to a line passing through a midpoint of the contact portion 13. The cross-sectional view of FIG. 4 also shows the width 400 of the body portion 9 of the insert 7 (i.e. the first width of the insert 7). In some embodiments, the width 400 may be about 1.156 cm (0.455 inches). FIG. 4 (as well as FIGS. 5-7) further illustrates the thickness 700 of the insert 7, which may be a uniform thickness 700 for the entire insert 7. In one embodiment, the thickness 700 may be about 0.381±0.051 mm (0.015±0.002 inches).

FIG. 4 further shows the rounded shape of the contact portion 13, which may be disposed in a center of the width 400 of the body portion 9 of the insert 7. In some embodiments, the contact portion 13 may have a predetermined width 600 that is less than about one third the width 400 of the body portion 9. Thus, for a width 400 of about 1.156 cm (0.455 inches), the width 600 may be about 0.386 cm (0.152 inches). When the contact portion 13 is provided in a rounded, for example cylindrical, shape, the contact portion 13 may have a predetermined diameter 900 (FIGS. 4 and 7). In one embodiment, the diameter 900 may be about 0.274 cm (0.108 inches). The perimeter of the cylindrical shape is shown in dashed lines in FIG. 4.

FIG. 5, taken along line 5-5 of FIG. 3, illustrates a cross-sectional view of the body portion of the insert 7. FIG. 5 shows a portion of the insert where no contact portion 13 exists. FIG. 6, taken along line 6-6 of FIG. 3, shows a cross-section of the end of the flange 11 of the insert 7 at the inlet 15. The cross-section shown in FIG. 6 is similar to the cross-section shown in FIG. 5; however, the insert 7 is wider at the end of the flange 11 than it is at the body portion 9 of the insert 7. The width of the flange 11 of the insert at the inlet 15 (i.e. the second width of the insert 7) 500 may be about 1.232 cm (0.485 inches).

FIG. 7, taken along line 7-7 of FIG. 3, shows a cross-sectional view along line 7-7 of FIG. 3. As shown in FIG. 7, the contact portion 13 has a length 800. In some embodiments, the contact portion length 800 may be less than about one tenth the total length 200 of the insert 7. Thus, for a total insert length 200 of between about 10.541 and 10.643 cm (4.150 and 4.190 inches), the contact portion length 800 may be between about 1.054 and 1.064 cm (0.415 and 0.419 inches). In one exemplary embodiment, the contact portion length 800 may be about 0.635±0.5 cm (0.250±0.2 inches).

FIG. 8 illustrates a sectional view of the turbine nozzle of FIG. 2 taken along line 8-8. The turbine nozzle 1 includes a pressure side 35 and a suction side 37 opposite the pressure side 35. Both the pressure side 35 and the suction side 37 are disposed between the leading edge 3 and the trailing edge 5. In FIG. 8, a portion of the insert 7 having the contact portion 13 is shown within the first passage 25 of the turbine nozzle 1. As mentioned above, the contact portion 13 is in contact, for example direct contact, with the inner walls 53 and 55 of the first passage 25. “Direct contact” as used herein indicates that there is no space or additional component(s) between the contact portion 13 and the inner walls 53 and 55. As shown in FIG. 8, there is space between the insert 7 and the walls of the turbine nozzle 1 forming the first passage 25. This space includes the gap 21 shown in FIG. 2, described above.

### INDUSTRIAL APPLICABILITY

The described system may be applicable to turbine nozzles of a GTE. Additionally, although the system has been described with respect to turbine nozzles in the first stage turbine assembly, the system may be applied to any turbine nozzle in any stage of the turbine section of a GTE. The construction could be typical of the remainder of the turbine stages within the turbine section of the GTE where cooling may be employed. Furthermore, although the above-mentioned insert has been described with respect to a turbine nozzle, the insert may be adapted to fit any airfoil, for example a turbine blade, in any stage of the turbine section of a GTE. Additionally, the insert system may be applied to any other nozzle or insulating tube applications for insulating cooling air flowing within the nozzle or tube. Moreover, the described cooling system may be applied in a variety of industries, for example, turbine manufacturing, heat exchange, energy, or aerospace.

The following operation will be directed to a turbine nozzle of a GTE; however, airflow though other airfoils or tubular apparatuses could be similar.

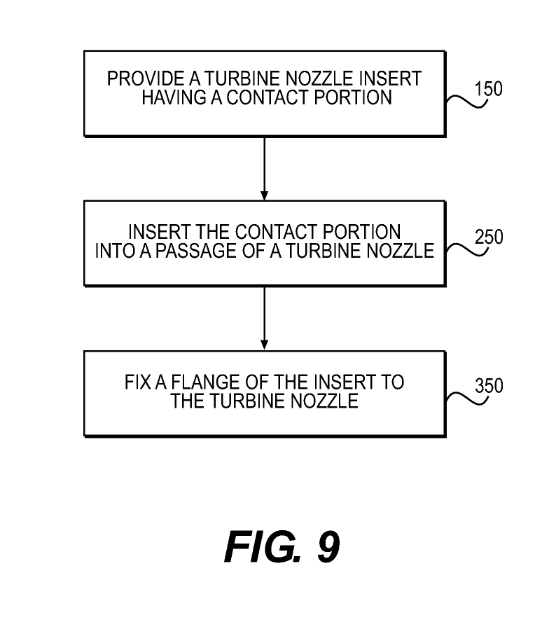

FIG. 9 shows a method of manufacturing or remanufacturing a turbine nozzle having an insert. In step 150, a turbine nozzle insert having a contact portion is provided. The insert may be formed from a section of tubing, for example metal tubing, having a thickness equal to the desired thickness of the insert 7. To form the insert 7, at least one die may be formed to allow the proper shape of the insert 7 to be pressed at one time. In some embodiments, a plurality of dies may be employed to form the insert 7 in a plurality of steps. The at least one die used to form the insert 7 is customized so that the insert 7 can be pressed having the proper dimensions of, e.g. the flange length, and the contact portion width, length, and diameter. The insert may be pressed and formed from a length of tubing having an original outer diameter of about 0.813 cm (0.320 inches). In one instance, Inconel™ 600 seamless tubing having a thickness equal to the thickness of the insert 7 can be pressed to form the insert 7.

To assemble the formed insert with the turbine nozzle 1, in step 250, the insert 7 may be inserted into a passage, for example the first passage 25, of the turbine nozzle 1. The free end 18 of the insert 7 having the contact portion 13 is first inserted in the first passage 25, and the insert 7 is pressed into the first passage 25 until further insertion is prevented by the flange 11, particularly by the tapered portion 12 of the flange 11. Once the insert 7 is fully inserted within the first passage 25 as shown in FIG. 2, in step 350 the flange 11 is fixed to the nozzle, for example by welding, such as laser welding, or brazing as mentioned above, although alternative fixation techniques may be employed.

Referring to the turbine nozzle 1 of FIG. 2, when put into operation in a GTE, in a first flow, cooling air 100 flows into the inlet 15 of the insert 7 and through the first passage 25 by flowing through the hollow interior of the insert 7. The cooling air 100 in the first flow then flows out of an outlet 17 of the insert 7, through any remaining length of the first passage 25, and out of the outlet 51 of the first passage 25. The flow of cooling air 100 through the insert 7 in the first passage 25 cools at least the portion of the turbine nozzle 1 adjacent the leading edge 3. In a second flow, which can occur simultaneously with the first flow, the cooling air 100 flows into the second passage 27 though an inlet 28. Cooling air 100 in the second flow then flows towards the trailing edge 5 of the turbine blade 1 in a meandering fashion through the third passage 29 and the fourth passage 31, and exits the interior of the turbine nozzle 1 by flowing out of the fourth passage 31 through apertures 19 disposed adjacent the trailing edge 5. The second flow of cooling air 100 through the internal passages of the turbine nozzle 1 also facilitates cooling of the turbine nozzle 1.

The insert 7 helps to prevent erosion of GTE components due to high temperatures. The space between the walls of the turbine nozzle 1 forming the first passage 25 and the insert 7, including the gap 21, is stagnant, that is, there is no air flow through the space. As described above, cooling air 100 flows through an interior of the insert 7. Thus, the space between the walls of the turbine nozzle 1 forming the first passage 25 and the insert 7, including the gap 21, provides an insulation layer between the nozzle walls and the cooling air 100 flowing through the insert, which helps to maintain the cooling air 100 at a lower temperature. Thus, the insert described above can help prevent GTE component wear due to high temperatures.

Furthermore, the free end 18 of the insert 7 allows for thermal growth due to the thermal difference (also referred to as thermal mismatch) between the insert 7 having cool air flowing therethrough and the turbine nozzle 1 exposed to hot gas flow from the combustor of the GTE (not shown). Due to the free end 18 of the insert 7 not being fixed within the first passage 25 of the turbine nozzle 1, some movement in the direction along the length of the insert 7 is allowed when the insert 7 is disposed within the first passage 25, thus preventing damage to the nozzle-insert assembly due to thermal growth. Although the free end 18 is not fixed within the first passage 25, the contact portion 13 restrains movement of the insert 7 in a direction perpendicular to the length of the insert 7. Therefore, the contact portion 13 prevents vibration, i.e. cantilever vibration, of the insert 7 within the first passage 25.

Additionally, providing the contact portion 13 reduces the surface area of the free end 18 of the insert 7 that contacts the inner walls of the internal airflow passage of the turbine nozzle 1. This reduction in contacting surface area provides for easy assembly of the insert 7 within the turbine nozzle 1, that is, easy insertion of the insert 7 into the turbine nozzle 1. Furthermore, the deformable contact portion 13 may allow for a transitional fit, such as an interference fit or a slip fit, between the insert 7 and the inner walls of a passage of the turbine nozzle 1, so that the passage of the turbine nozzle 1 can accommodate the insert 7. Predetermining the diameter of the contact portion as described above may be important in order to provide the proper fit of the insert 7 within a passage of the turbine nozzle 1. Furthermore, the above-described nozzle insert 7 can be provided as a one-size-fits-all component to fit, for example, any turbine nozzle of any stage in a GTE.

Although the contact portion 13 has been described as having a cylindrical shape, such as curved ribs, the contact portion 13 is not limited to such a shape. For example, in some instances the contact portion 13 may have a spherical shape, such as spherical protrusions. In the case where there may be manufacturing inconveniences to form a spherical shaped contact portion 13, however, a cylindrical shaped contact portion 13 may be formed.

It will be apparent to those skilled in the art that various modifications and variations can be made to the disclosed turbine cooling system. Other embodiments will be apparent to those skilled in the art from consideration of the specification and practice of the disclosed system and method. It is intended that the specification and examples be considered as exemplary only, with a true scope being indicated by the following claims and their equivalents.

What is claimed is:

1. An insert for an airfoil comprising:
an elongated hollow body portion;
a flange portion formed at a first end of the elongated body portion; and
a contact portion formed at a second end of the elongated body portion opposite the first end.

2. The insert of claim 1, wherein the first end and the second end of the body portion are open and the insert is configured to allow airflow through the insert between the first end and the second end.

3. The insert of claim 1, wherein the body portion includes a bowed cross-sectional shape.

4. The insert of claim 1, wherein the contact portion comprises a plurality of rounded protrusions, a first protrusion formed on a first side of the insert and a second protrusion formed on a second side of the insert opposite the first side.

5. The insert of claim 1, wherein the contact element has a width less than one third a width of the body portion.

6. The insert of claim 1, wherein the contact portion is formed in a middle of a width of the body portion.

7. The insert of claim 1, wherein the contact portion extends along the body portion towards the first end.

8. The insert of claim 7, wherein the contact portion has a length less than one tenth a total length of the insert.

9. The insert of claim 1, wherein a width of the flange portion is greater than a width of the body portion.

10. A turbine nozzle of a gas turbine engine comprising:
a plurality of airflow passages formed within the turbine nozzle; and
an insert disposed within one of the plurality of airflow passages, the insert comprising:
an elongated hollow body portion extending along a length of the one of the plurality of passages;
a flange portion formed at a first end of the elongated body portion and extending from the one of the plurality of passages; and
a contact portion formed at a second end of the elongated body portion opposite the first end.

11. The turbine nozzle of claim 10, wherein the contact portion contacts an internal wall of the one of the plurality of passages.

12. The turbine nozzle of claim 10, wherein an interior of the body portion of the insert is configured to receive an airflow.

13. The turbine nozzle of claim 10, wherein the body portion includes a bowed cross-sectional shape.

14. The turbine nozzle of claim 10, wherein the contact portion comprises a plurality of rounded protrusions, a first protrusion formed on a first side of the insert, and a second protrusion formed on a second side of the insert opposite the first side.

15. The turbine nozzle of claim 10, wherein the contact portion is formed in a middle of a width of the body portion.

16. The turbine nozzle of claim 10, wherein the flange portion is fixed to the turbine nozzle, and wherein the second end is freely disposed within the one of the plurality of passages.

17. A method of manufacturing or remanufacturing a turbine nozzle having a plurality of internal passages, the method comprising:
providing an insert, the insert comprising:
an elongated hollow body portion;
a flange portion formed at a first end of the elongated body portion; and
a contact portion formed at a second end of the elongated body portion opposite the first end;
inserting the contact portion into the one of the plurality of passages; and
fixing the flange portion to the turbine nozzle.

18. The method of claim 17, wherein the contact portion is inserted into the one of the plurality of passages until the flange portion contacts an exterior portion of the turbine nozzle.

19. The method of claim 17, wherein a tapered portion of the flange portion is fixed to the turbine nozzle.

20. The method of claim 17, wherein the insert is provided by pressing a tube with at least one die to form the insert.
